(19) United States
(12) Patent Application Publication
(10) Pub. No.: US 2008/0172991 A1
(43) Pub. Date: Jul. 24, 2008

(54) SADDLE GIRTH

(75) Inventor: Kenneth John Bates, Darlington (AU)

Correspondence Address: KNOBBE MARTENS OLSON & BEAR LLP, 2040 MAIN STREET, FOURTEENTH FLOOR, IRVINE, CA, 92614, US

(73) Assignee: Hammersmith Nominees Pty Ltd, West Perth (AU)

(21) Appl. No.: 11/970,454

(22) Filed: Jan. 7, 2008

(30) Foreign Application Priority Data
Jan. 9, 2007 (AU) 2007900074

(51) Int. Cl. B68C 1/14

(52) U.S. Cl. 54/23

(57) ABSTRACT

A saddle girth for an equestrian saddle comprises a main belt carrying buckles for attachment of the girth to girth straps of the saddle, and an air bag attached to a side of the main belt facing towards the chest of the horse, the air bag being so positioned that it acts to distribute the load in the area of the sternum. In the preferred embodiment the straps and the main belt are of non-elastic material, and the straps are attached to the main belt via at least one elastic strap, the main belt being of a construction such that it will not bow transversely under the effect of applied tension.

### BACKGROUND OF THE INVENTION

1. Field of the Invention

The present invention relates to a saddle girth for an equestrian saddle.

2. Description of the Prior Art

In equestrian saddles, it is conventional practice to fasten the saddle to a horse by a girth which passes around the chest of the horse and which is attached at each end to girth straps which hang from the saddle itself. Conventional saddle girths apply a substantial pressure to the sternum and this can give rise to discomfort.

### SUMMARY OF THE INVENTION

According to on aspect of the present invention there is provided a saddle girth for an equestrian saddle, comprising a main belt carrying buckles for attachment of the girth to girth straps of the saddle, and an air bag attached to a side of the main belt facing towards the chest of the horse, the air bag being so positioned that it acts to distribute the load in the area of the sternum.

In the preferred embodiment, the air bag is generally flat and filled within its interior with a resiliently compressible open cell foam. It is composed of opposed layers of sheet material sealed together to enclose the foam filling the bag containing air at atmospheric pressure sealed within the bag at atmospheric pressure at the time of manufacture. Although the air bag is of substantially uniform thickness over a substantial part of its area, it is preferred for the inner face of the bag, that is the face closest to the sternum, to be formed with a chamfer or skive at each end portion and we have determined that this significantly adds to the comfort when the girth is in use.

In a preferred embodiment, the buckles are carried by straps attached to the opposite side of the main belt. The main belt with air bag and straps is enclosed within an outer casing of a relatively soft flexible material.

The main belt can be formed from non-elastic material such as multi-layer webbing of the type used for conveyor belting and the like and is such that when under load it will not tend to bow transversely under the effect of the tension and which would diminish the effect of the air bag in applying even load to the sternum. Other materials having these characteristics could alternatively be used. Alternatively the main belt can be formed from an elastic material, with the air bag being attached to a relatively stiff backing plate having sufficient flexibility to enable the plate to bend to follow the curvature of the chest.

According to another aspect of the invention there is provided a saddle girth for an equestrian saddle comprising a main belt carrying buckles for attachment of the girth to girth straps of the saddle, an air bag positioned at a side of the main belt facing towards the chest of the horse, and an outer casing of a relatively soft flexible material for the main belt with air bag, wherein the air bag is generally flat and filled within its interior with a resiliently compressible open cell foam and contains air at atmospheric pressure, the air bag being so mounted that it is able to bend to follow the curvature of the chest without bowing transversely under the effect of tension applied to the girth and to distribute the loading in the area of the sternum.

### BRIEF DESCRIPTION OF THE DRAWINGS

FIG. 1 is a view from the underside or outer side of the internal structure of a saddle girth in accordance with an embodiment of the invention prior to placement within an outer cover;

FIG. 2 is a view of the structure of FIG. 1 from the upper side or inner side;

FIG. 3 is a view of the internal structure from one side;

FIG. 4 is a view from the upper side of the overall saddle girth with the outer cover in place;

FIG. 5 is an underside view corresponding to FIG. 4;

FIG. 6 is a fragmentary section through an air bag of the saddle girth;

FIG. 7 is a fragmentary section of the internal structure of an alternative embodiment.

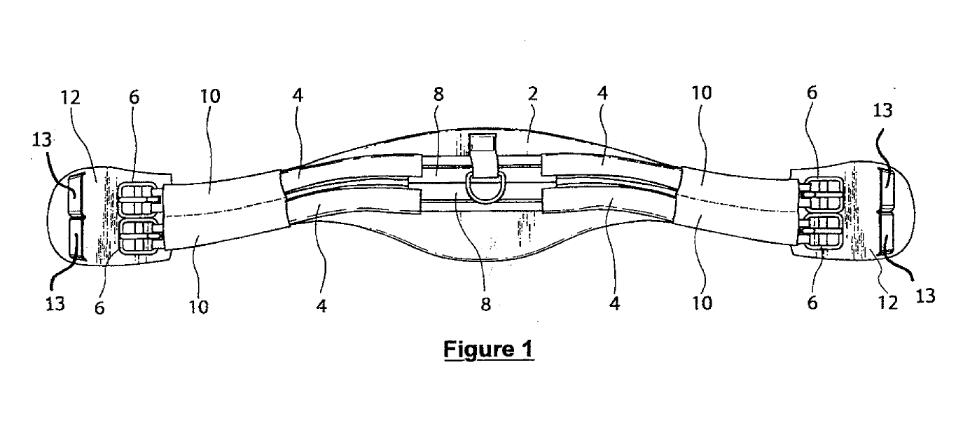

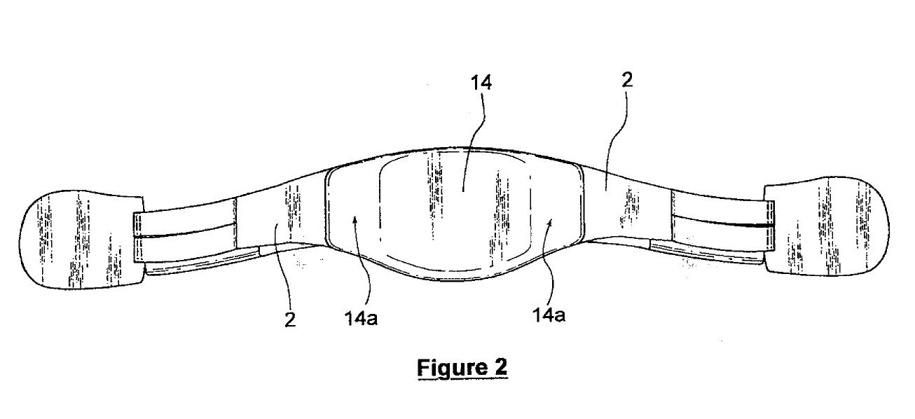

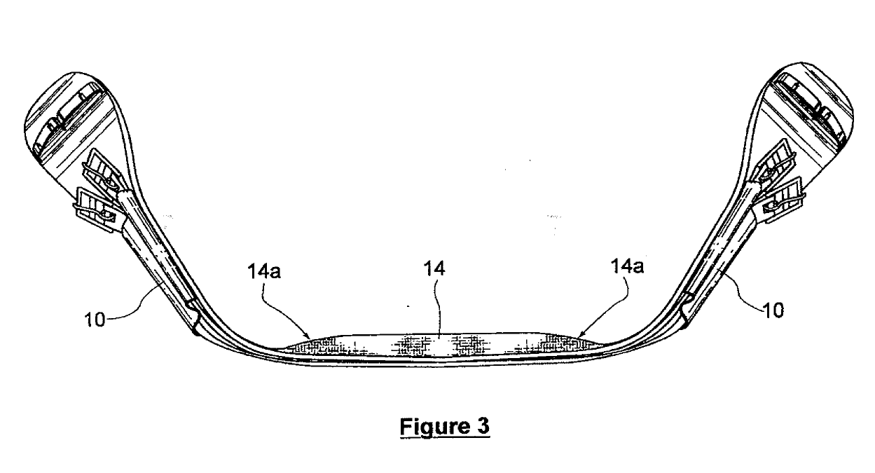

### DESCRIPTION OF THE PREFERRED EMBODIMENTS

A saddle girth in accordance with the preferred embodiment of the invention comprises main belt or band 2 of non-elastic material. Sets of straps 4 with buckles 6 for attachment to the girth straps of a saddle are attached to the underside of the belt 2. In the embodiment shown the straps 4 themselves are formed of non-elastic webbing and are attached at their inner ends to elastic straps 8 secured by stitching to the outer or underside of the belt 2. The outer end portions of the straps 4 are guided in sleeves 10 attached to the underside of the belt 2 and the buckles 6 at the outer ends of the straps 4 lie against flaps 12 of flexible material attached to the ends of the belt 2. The flaps 12 carry strap loops 13, one associated with each buckle 6, for passage of the girth straps.

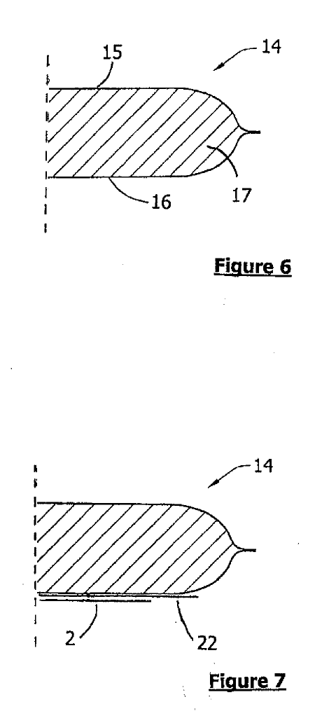

At its inner or upper side, the belt 2 carries an air bag 14 which is attached to the central part of the belt 2 by gluing. The air bag 14 consists of upper and lower sheets of impervious material, such as PVC, scaled together around the periphery, with the air bag having a filling consisting of a layer of an open cell, resiliently compressible, foam which occupies substantially the entirety of the interior of the bag. The air bag is not inflated with air at above atmospheric pressure but, rather, contains air at atmospheric pressure which is sealed within the bag during manufacture. The construction of the air bag is substantially as described in U.S. Pat. No. 6,481,189 to which reference may be made. FIG. 6 is a fragmentary section through the air bag and shows the upper and lower sheets 15, 16 sealed together at their periphery, and the foam filling 17. The bag is used to spread the load over a relatively large area of the sternum of the animal. Although the resulting structure of the bag is substantially flat and of uniform thickness over a substantial part of its area, nevertheless it is preferred to shape the inner surface of the bag (that is, the surface closer to the sternum) with a chamfer or skive 14a at each end portion to add to the comfort of the animal when the girth is under load. This shaping is provided by corresponding chamfering or skiving of the layer of foam in the bag. It is to be noted that to provide as large a load-bearing area as possible, the main belt 2 is shaped to provide a widened zone in its central part, and the air bag 14 is shaped at its lateral edges to match that shaping.

The belt 2 is of a non-elastic material which is such that when under a substantial tension as applied when the girth straps are tightened, the tension will not cause it to bow across its width and thereby reduce the surface area over which the load is applied to the animal via the air bag. We have determined that this can be achieved by fabricating the main belt from multi-layer webbing of the type used in the conveyor belting and in treadmills for exercise equipment. Such webbing is typically formed by a series of layers of woven material, three layers for example, impregnated and bonded together to form a structure of high strength. It is, however, to be understood that the main belt can be fabricated from other materials having the required characteristics.

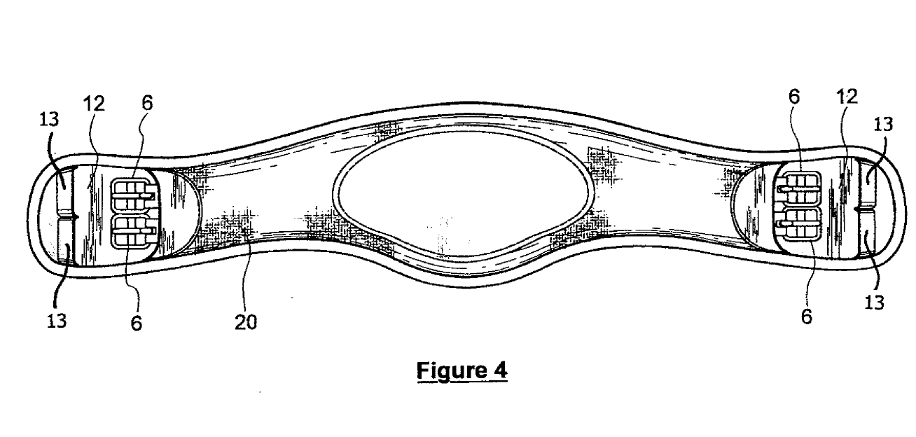

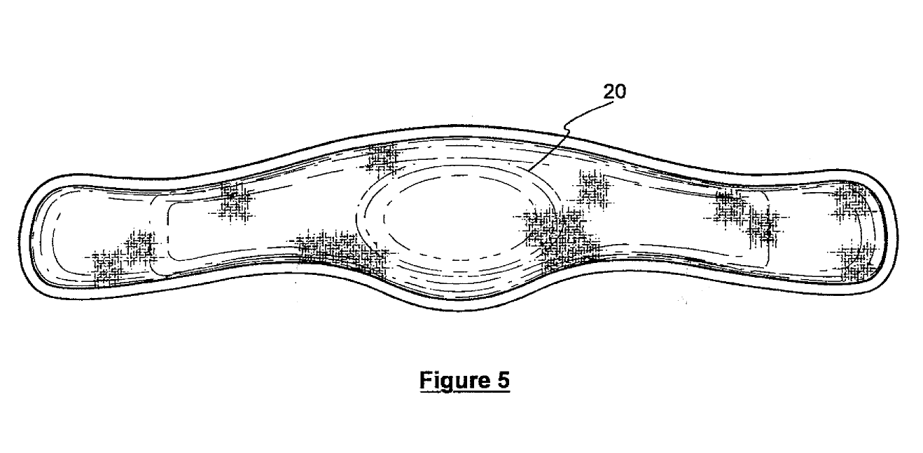

The main belt with the straps and air bag attached is encased within an outer casing 20 of a soft flexible material such as is shown in FIGS. 4 and 5 with the buckles 6 being exposed at each end. The material for the outer casing may itself be of an open cell foam laminated at its inner and outer faces with wear-resistant material.

In an alternative, the main belt is formed from an elastic material and carries in its central part a plate of the same shape as the air bag and to which the air bag is attached by gluing. The plate is relatively stiff with sufficient flexibility to enable it to bend to follow the curvature of the chest but it will not bow across its width under the applied tension and thereby reduce the surface area over which the load is applied to the animal via the air bag. The effect of the plate, therefore, is to ensure that the air bag is firmly applied to the sternum, as occurs when the main strap is formed from non-elastic material as described above. With a main belt of elastic material, the belt will usually be of constant width throughout its length and the air bag and its backing plate can be of greater width than the belt so as to maximise the surface area over which the load is applied by the air bag. The buckles may be attached to the opposite end portions of the elastic belt in this alternative, although other arrangements for attaching the buckles can be adopted. FIG. 7 is a fragmentary section showing the main belt 2, air bag 14, and air bag support plate 22 of this embodiment. As with the previous embodiment, the main belt 2 with air bag 14 is enclosed within outer casing 20 and the overall configuration is substantially as shown in FIGS. 4 and 5.

The embodiment has been described by way of example only and modifications are possible within the scope of the invention.

1. A saddle girth for an equestrian saddle, comprising a main belt carrying buckles for attachment of the girth to girth straps of the saddle, and an air bag attached to a side of the main belt facing towards the chest of the horse, the air bag being so positioned that it acts to distribute the load in the area of the sternum.

2. A saddle girth according to claim 1, wherein the air bag is generally flat and filled within its interior with a resiliently compressible open cell foam.

3. A saddle girth according to claim 2, wherein the air bag is composed of opposed layers of sheet material sealed together to enclose the foam filling, the bag containing air at atmospheric pressure sealed within the bag at atmospheric pressure at the time of manufacture.

4. A saddle girth according to claim 3, wherein the air bag is of substantially uniform thickness over a substantial part of its area, with the face of the bag closest to the sternum being formed with a skive at each end portion.

5. A saddle girth according to claim 3, wherein the buckles are carried by straps attached to a side of the main belt opposite to the first-mentioned side.

6. A saddle girth according to claim 5, wherein the straps and the main belt are of non-elastic material, and the straps are attached to the main belt via at least one elastic strap.

7. A saddle girth according to claim 6, wherein the straps pass through sleeves attached to the main belt, the sleeves acting to guide the straps.

8. A saddle girth according to claim. 3, wherein the main belt is formed of a non-elastic material of such construction that when under load it does not bow transversely under the effect of tension.

9. A saddle girth according to claim 3, wherein the air bag is attached to a central part of the main belt intermediate its opposite ends, the central part is of increased width relative to that of the opposite end parts of the belt, and the air bag is mounted in the central part and has a width corresponding to that of the central part so as to match the shaping of the central part.

10. A saddle girth according to claim 6, wherein the air bag is attached to a central part of the main belt intermediate its opposite ends, the central part is of increased width relative to that of the opposite end parts of the belt, and the air bag is mounted in the central part and has a width corresponding to that of the central part so as to match the shaping of the central part.

11. A saddle girth according to claim 3, wherein the main belt is of an elastic material.

12. A saddle girth according to claim 11, wherein the air bag is attached to a relatively stiff backing plate having sufficient flexibility to enable the plate to bend under the applied loading to follow the curvature of the chest.

13. A saddle girth according to claim 5, wherein the main belt with air bag is enclosed with an outer casing of a relatively soft flexible material.

14. A saddle girth for an equestrian saddle comprising a main belt carrying buckles for attachment of the girth to girth straps of the saddle, an air bag positioned at a side of the main belt facing towards the chest of the horse, and an outer casing of a relatively soft flexible material for the main belt with air bag, wherein the air bag is generally flat and filled within its interior with a resiliently compressible open cell foam and contains air at atmospheric pressure, the air bag being so mounted that it is able to bend to follow the curvature of the chest without bowing transversely under the effect of tension applied to the girth and to distribute the loading in the area of the sternum.
